(19) United States
(12) Patent Application Publication
(10) Pub. No.: US 2011/0205736 A1
(43) Pub. Date: Aug. 25, 2011

(54) Dynamic Light-Spot Pictures Generation Device

(76) Inventors: Shuei-Yuan LEE, Taipei City (TW); Chia-Chun Lee, Taipei City (TW)

(21) Appl. No.: 12/253,958

(22) Filed: Oct. 18, 2008

(51) Int. Cl. F21V 8/00

(52) U.S. Cl. 362/237

(57) ABSTRACT

A dynamic light-spot pictures generation device includes a stack of photoreceptors, light-source members, and a driving device which is connected to the light-source members. The light-source members produce projection light, the photoreceptors receive light produced by the light-source members at opposite positions, each photoreceptor includes a light guiding zone of a proper area, a surface of the light guiding zone contains a pattern formed by reflection points, and the reflection points of each photoreceptor are arranged according to a different dynamic continuous pattern. By the driving device, the light-source members sequentially project light which travels along the light guiding zone and is reflected outward at each reflection point, allowing each reflection point to form a specific light spot, so that a specific glossy pattern is formed by the plural reflection points, further constituting continuous dynamic visual pictures by the plural photoreceptor patterns which are displayed orderly.

### BACKGROUND OF THE INVENTION

a) Field of the Invention

The present invention relates to a dynamic light-spot pictures generation device, and more particularly to a generation device which forms a plurality of glossy pattern by using photoreceptors to reflect light from a plurality of reflection point, thereby constituting continuous dynamic light-spot pictures.

b) Description of the Prior Art

An ordinary dynamic pictures generation device is usually provided with a light-emitting-diode matrix plane which is connected to a control circuit to illuminate the light emitting diodes at different positions sequentially, thereby constituting continuous dynamic pictures. However, as cost of the light-emitting-diode matrix plane is high, and a specific program needs to be written into the control circuit that the dynamic pictures can be displayed, construction cost of that product is too high to be applied generally. Another dynamic pictures generation device is provided with a liquid crystal display screen which is similarly connected to a control circuit such that the continuous dynamic pictures can be formed on the liquid crystal display screen by the control circuit. As cost of the liquid crystal display screen is even higher than that of the light-emitting-diode matrix plane, and the control circuit is even more complicated, this kind of device is even difficult to be applied broadly.

### SUMMARY OF THE INVENTION

The primary object of the present invention is to provide a dynamic light-spot pictures generation device, wherein continuous dynamic visual pictures are formed by light-spot figures which are constituted by using a plurality of reflection point arranged by a plurality of photoreceptor to reflect light.

The aforementioned dynamic light-spot pictures generation device includes a stack of photoreceptors, a stack of light-source members, and a driving device which is connected to the light-source members, wherein the light-source members produce projection light, the photoreceptors receive light produced by the light-source members at opposite positions, a photoreceptor includes a light guiding zone of a proper area, a surface of the light guiding zone is provided with a pattern which is formed by a plurality of reflection point, and the reflection points of each photoreceptor are arranged according to different continuous patterns, allowing the light-source members to project light on the photoreceptors at opposite positions sequentially by the driving device, with light traveling along the light guiding zone of the photoreceptor, and being reflected outward at each reflection point, so as to form a specific light spot at the reflection point and to form a specific glossy pattern by plural light spots, thereby constituting continuous dynamic visual pictures from plural patterns of photoreceptor which are displayed sequentially.

For the aforementioned dynamic light-spot pictures generation device, the light-source member is provided at a side of the photoreceptor to facilitate projection light to travel along the light guiding zone of the photoreceptor.

For the aforementioned dynamic light-spot pictures generation device, the reflection point which is provided on the surface of the light guiding zone of the photoreceptor is a pore which is concaved inward on the surface by a proper depth.

For the aforementioned dynamic light-spot pictures generation device, the pore of the reflection point can be in a triangular, rhombic, circular or other geometric shape to reflect light, in accordance with the required pattern.

For the aforementioned dynamic light-spot pictures generation device, the light-source member can be a light emitting diode or light bulb of a various color.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional exploded view of the present invention.

FIG. 2 shows a cutaway view of the present invention.

FIG. 3 shows a circuit diagram of a preferred embodiment of the present invention.

FIG. 4 shows a schematic view of an embodiment of a reflection part which reflects light, in accordance with the present invention.

FIG. 5 shows a plan view of a photoreceptor of a first embodiment of the present invention.

FIG. 6 shows a three-dimensional view of a first embodiment of the present invention.

FIG. 7 shows a plan view of a photoreceptor of a second embodiment of the present invention.

FIG. 8 shows a three-dimensional view of a second embodiment of the present invention.

FIG. 9 shows a three-dimensional explode view of another embodiment of assembly of the present invention.

FIG. 10 shows a plan view of a photoreceptor of a third embodiment of the present invention.

FIG. 11 shows a three-dimensional view of a third embodiment of the present invention.

FIG. 12 shows a plan view of a photoreceptor of a fourth embodiment of the present invention.

FIG. 13 shows a three-dimensional view of a fourth embodiment of the present invention.

### DETAILED DESCRIPTION OF THE PREFERRED EMBODIMENTS

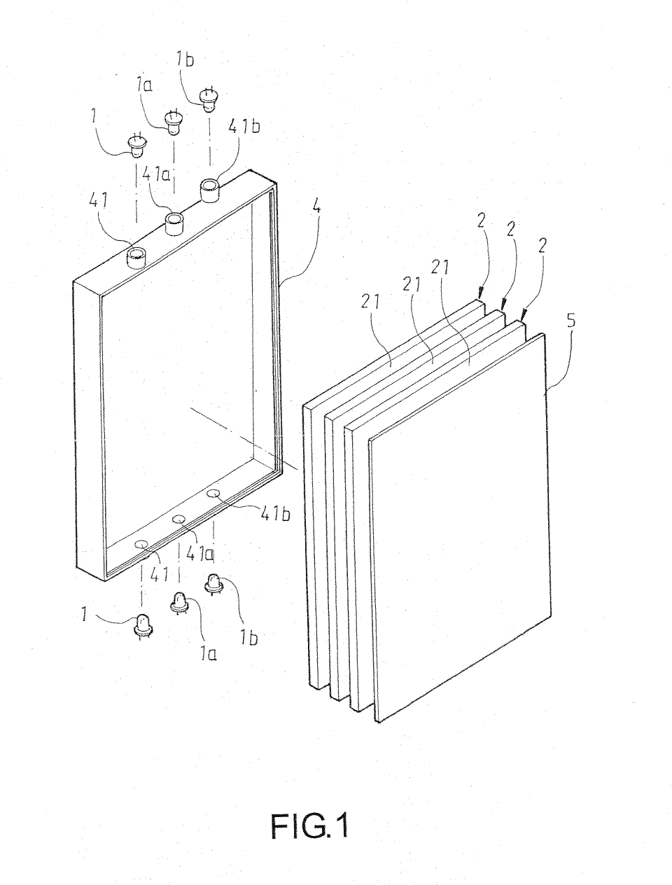

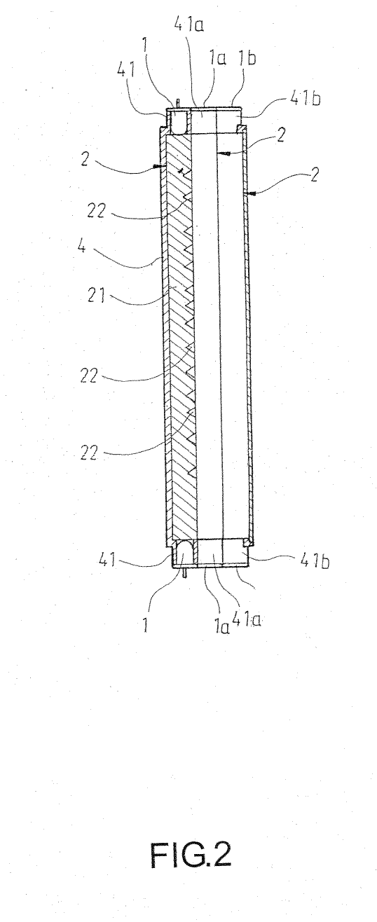

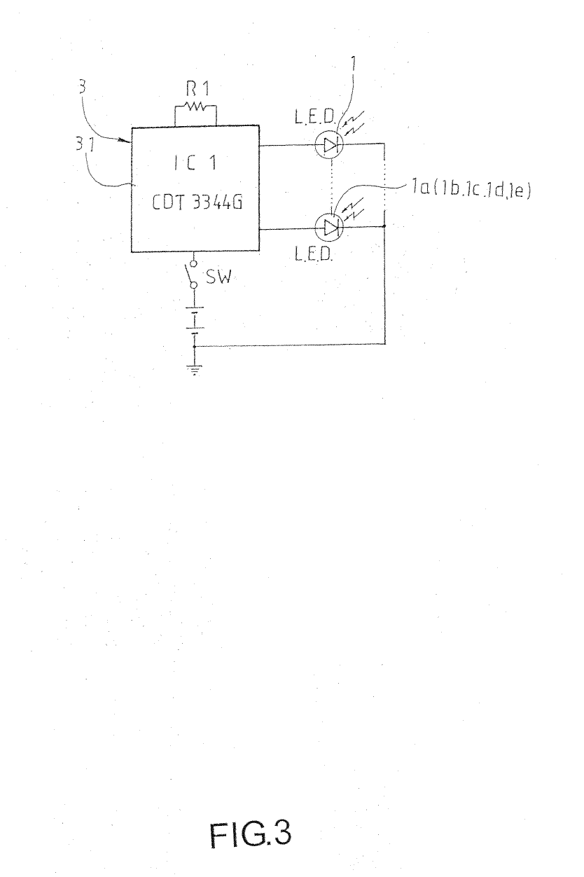

Referring to FIG. 1 and FIG. 2 at a same time, in association with FIG. 3, the present invention comprises primarily a plurality of light-source member 1 (1a, 1b, . . . ), a plurality of photoreceptor 2 at an opposite position, and a driving device 3 which is connected to the light-source members 1 (1a, 1b, . . . ). In the present embodiment, the photoreceptors 2 are stacked and fixed in a frame 4, wherein a side of the frame 4 is provided with slots 41 (41a, 41b, . . . ) which correspond to the photoreceptors 2 and are run-through, so as to hold the light-source members 1 (1a, 1b, . . . ) which can be light emitting diodes or light bulbs of various colors to produce projection light.

The photoreceptors 2 are in a plate-shape and are made by a light guiding material, to receive light produced by the light-source members 1 (1a, 1b, . . . ). Each photoreceptor 2 includes a light guiding zone 21 of a proper area, a surface of the light guiding zone 21 is provided with a plurality of reflection point 22, and the reflection points 22 of each photoreceptor 2 are arranged according to various continuous patterns, wherein a reflection point 22 is a pore which is concaved inward on the surface of light guiding zone 21 by a proper depth, and the pore can be in a triangular, rhombic, circular or other geometric shape to reflect light, depending upon the required patterns.

The driving device 3 is provided with an integrated circuit 31 which contains sequential output points, with each output point being connected with the light-source members 1 (1a, 1b, . . . ).

A panel 5 is provided on a surface of the stacked photoreceptors 2.

Accordingly, after activating the driving device 3, the light-source members 1 (1a, 1b, . . . ) project light sequentially to the photoreceptors 2 at opposite positions (the light-source members 1, 1a, 1b, are illuminated orderly), allowing light to travel along the light guiding zone 21 of the photoreceptor 2 at the opposite position and to be reflected outward at each reflection point 22, so as to form a specific light spot at the reflection point 22 and to constitute a glossy pattern by the photoreceptors 2, thereby generating continuous dynamic visual pictures from the glossy patterns that are displayed orderly by the photoreceptors 2.

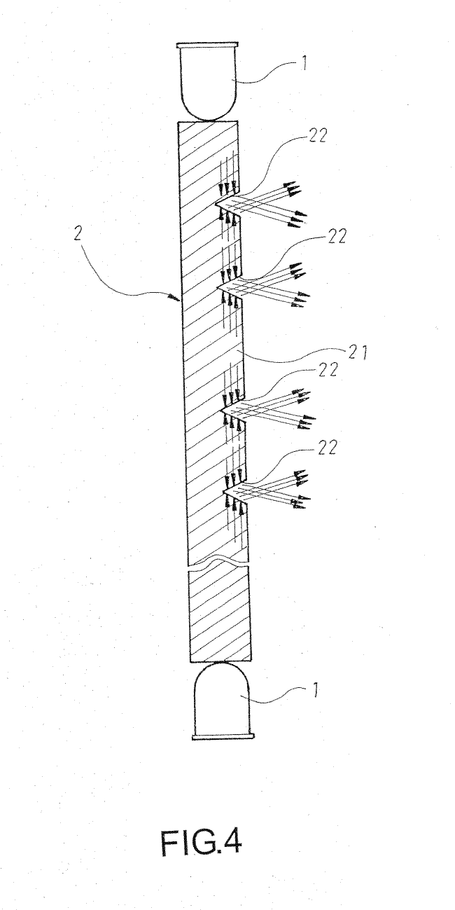

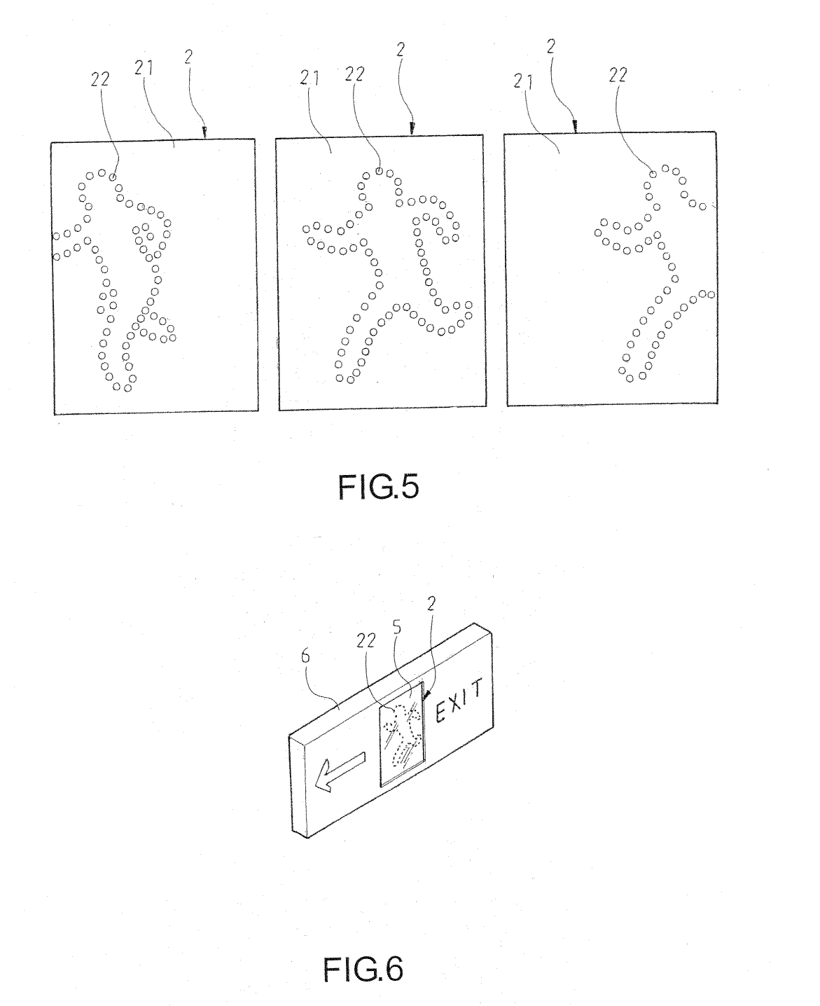

Referring to FIGS. 4 to 6 at a same time, in association with FIG. 1, a first embodiment of the present invention includes plural reflection points 22 arranged by plural photoreceptors 2 according to the different continuous patterns. As shown in FIG. 5, each photoreceptor 2 is provided with the continuous pattern of a different gesture, such as a running man, arranged by plural reflection points 22 (as the gestures running from right to left in FIG. 5). The light-source members 1 (1a, 1b, . . . ), the photoreceptors 2, the driving device 3 and the frame 4, after being assembled, are placed at a center position of an emergency fire exit light 6, and when the emergency fire exit light 6 is turned on, the driving device 3 controls the light-source members 1 (1a, 1b, . . . ) to project light sequentially on the photoreceptors 2 at the opposite positions, so as to form the different glossy pattern from each photoreceptor 2 due to reflection of the reflection points 22. As the surface of the stacked photoreceptors 2 is provided with the panel 5, when any one photoreceptor 2 forms a glossy pattern, other reflection points 22 of the photoreceptors 2 on which light is not projected by the light-source members 1 (1a, 1b, . . . ) at the opposite positions will not be displayed, and by an effect of persistence of vision, the changing glossy patterns that are displayed by the photoreceptors 2 will constitute the continuous dynamic visual pictures like a man is running. Accordingly, in addition to that the emergency fire exit light 6 can enhance an indication effect of an escape route to improve a shortcoming that the conventional emergency fire exit light 6 is easily ignored due to stationary illumination, attention of children can be increased by the dynamic visual pictures, allowing the children to be interested in the dynamic visual pictures and to raise a question about a function. Furthermore, parents can take this chance to explain the purpose of emergency fire exit light 6, how to escape successfully following the indication of emergency fire exit light 6, and items to be noted during escape, thereby achieving an effect of educating in opportunity common knowledge of fire control and escape from an early childhood.

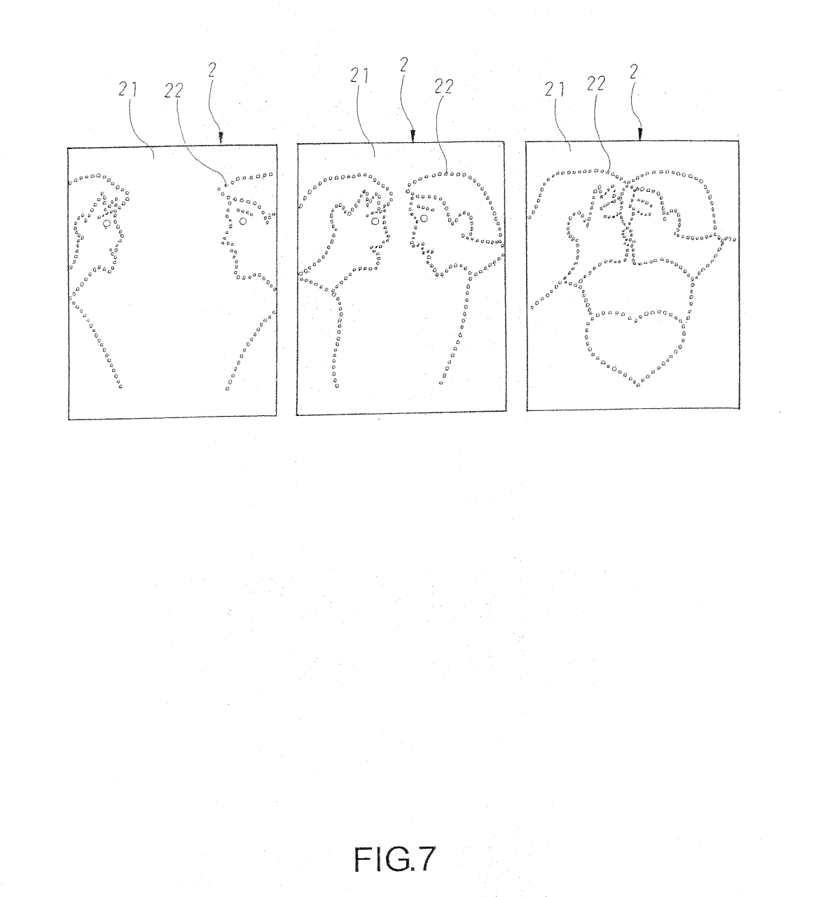

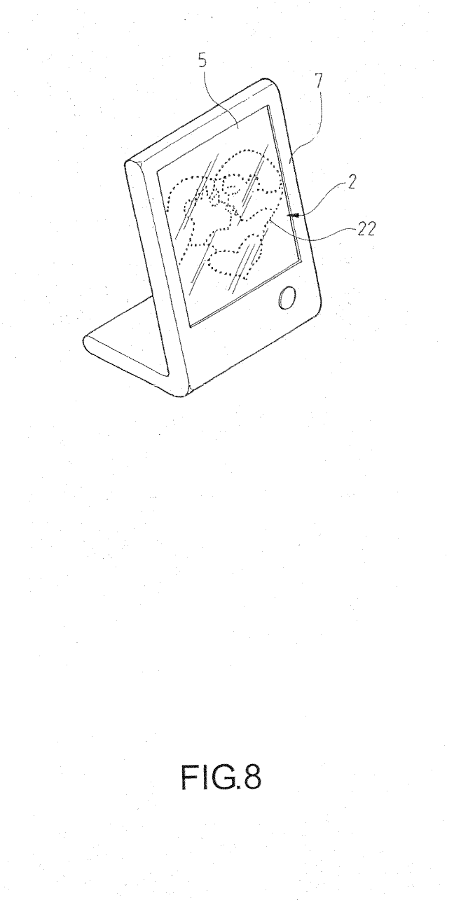

Referring to FIG. 7 and FIG. 8 at a same time, in association with FIG. 1, in a second embodiment of the present invention, each photoreceptor 2 is provided with the pattern, such as a figure of man and woman, arranged by plural reflection points 22, and the figures of man and woman of different photoreceptors 2 are the continuous patterns of different gestures formed by approaching to a center position from outside and then being touched with one another. The light-source members 1 (1a, 1b, . . . ), the photoreceptors 2, the driving device 3 and the frame 4, after being assembled, are placed in a photo frame 7 (or a display rack), and when the driving device 3 allows the light-source members 1 (1a, 1b, . . . ) to project light sequentially on the photoreceptors 2 at the opposite positions, different glossy patterns formed are displayed orderly by the photoreceptors 2, thereby constituting the continuous dynamic visual pictures such as the figures of man and woman in an intimate gesture. The photo frame 7 can be put on a desktop in a coffee shop or a restaurant to attract consumers, thereby increasing a mood of dining or dating.

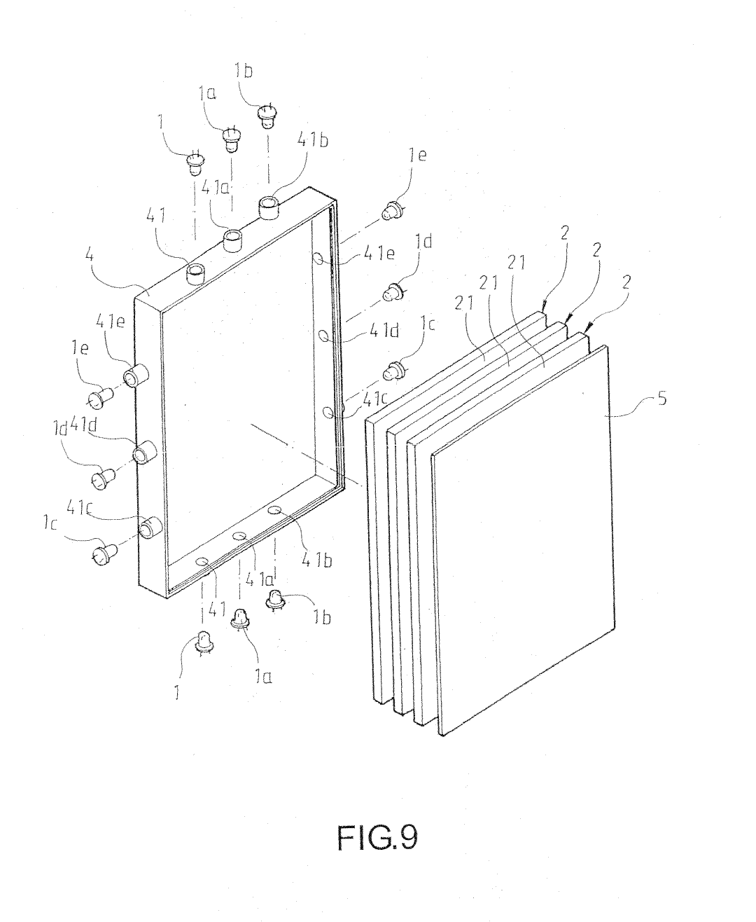

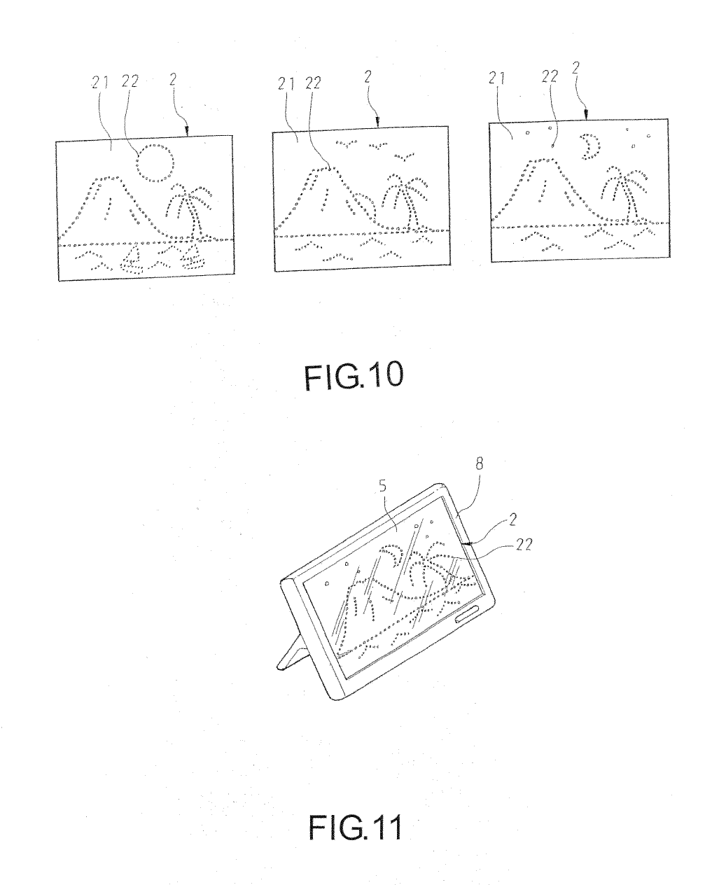

Referring to FIG. 9, FIG. 10 and FIG. 11, in association with FIG. 1, in a third embodiment of the present invention, in addition to that the light-source members 1 (1a, 1b, . . . ) are installed on an upper and lower side of the frame 4, as in the aforementioned embodiments, a left and right side of the frame 4 can be also added with plural slots 41c, 41d, 41e, to hold plural light-source members 1c, 1d, 1e, . . . ; whereas, each photoreceptor 2 which is provided on each side of the light-source member 1 (1a, 1b, 1c, 1d, 1e, . . . ) at the opposite position, is provided with the patterns of landscape, arranged by plural reflection points 22. In addition, scenes of different photoreceptors 2 are different continuous patterns like high noon, sunset or dark night. The light-source members 1 (1a, 1b, 1c, 1d, 1e, . . . ), the photoreceptors 2, the driving device 3 and the frame 4, after being assembled, are placed in a display board 8 (or a display cabinet), and when the driving device 3 makes the light-source members 1 (1a, 1b, 1c, 1d, 1e, . . . ) to project light sequentially (the light-source members 1, 1c, 1a, 1d, 1b, 1e, are illuminated orderly), allowing each photoreceptor 2 to display the different glossy pattern orderly, so as to constitute the continuous dynamic pictures of the same scenes but different view of time. The display board 8 can be put on a desktop or wall in a house or a public location, to achieve an effect of displaying the continuous dynamic visual pictures.

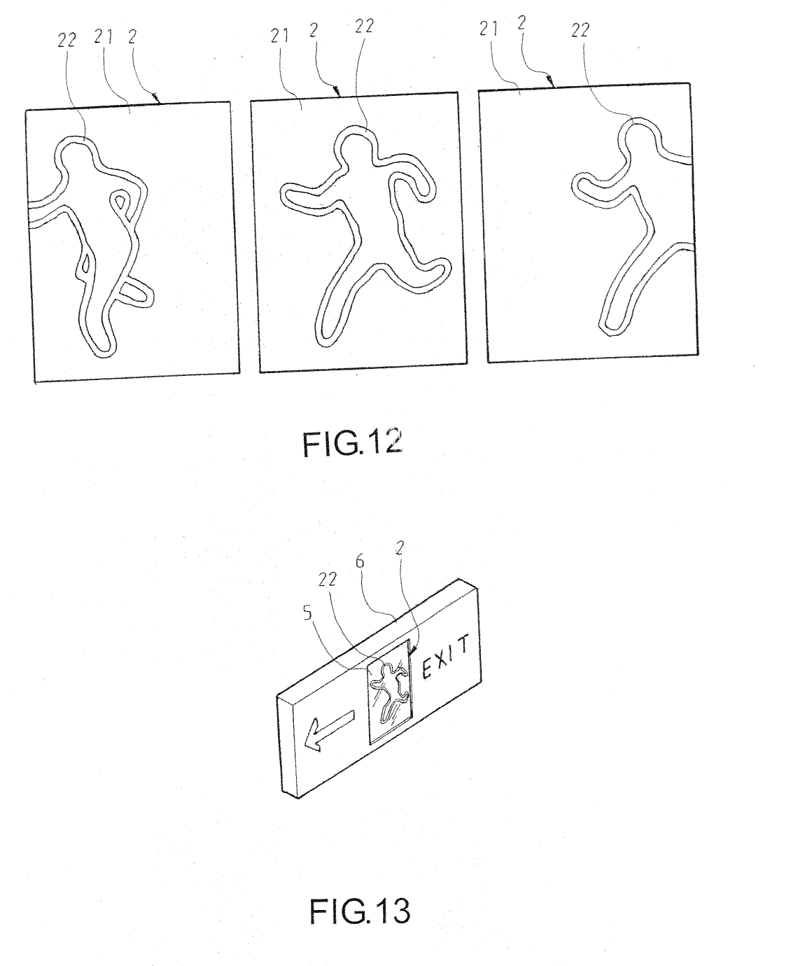

Referring to FIG. 12 and FIG. 13, in a fourth embodiment of the present invention, the reflection points 22 of each photoreceptor 2 can be connected by grooves of a same depth, allowing the reflection points 22 of each photoreceptor 2 to form the different continuous pattern in a groove shape. When the present embodiment is applied to the emergency fire exit light 6 as shown in FIG. 1, the light-source members 1 (1a, 1b, . . . ) project light sequentially on the photoreceptors 2 at the opposite positions (the light-source members 1, 1a, 1b, . . . are illuminated orderly), allowing light to travel along the light guiding zone 21 of the photoreceptor 2 at the opposite position and to be reflected outward at the reflection point 22, thereby constituting another kind of continuous dynamic visual pictures like a running man, by the changing glossy patterns displayed orderly by the photoreceptors 2.

In the aforementioned embodiments, the light-source members 1 (1a, 1b, 1c, 1d, 1e, . . . ) can be a single-color illuminator or an illuminator of different color, allowing the continuous dynamic visual patterns of single color, different color or multi-color can be manifested when light is projected on the photoreceptors 2 at the opposite positions by the light-source members 1 (1a, 1b, 1c, 1d, 1e, . . . ) to form the glossy patterns.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A dynamic light-spot pictures generation device, comprising a stack of plural photoreceptors, a plurality of light-source member, and a driving device which is connected to the light-source members, wherein the light-source members produce projection light, the photoreceptors receive light produced by the light-source members, each photoreceptor includes a light guiding zone of a proper area, a surface of the light guiding zone is provided with a plurality of reflection point, and each reflection point of the photoreceptor is arranged according to a different continuous pattern; by the driving device, light being projected by the light-source members sequentially, traveling along the light guiding zone at an opposite position of the light-source member, and reflected outward at each reflection point, so as to form a specific light spot at each reflection point and to form a specific glossy pattern by the plural reflection points, thereby constituting continuous dynamic visual pictures by the plural patterns of photoreceptors.

2. The dynamic light-spot pictures generation device, according to claim 1, wherein the light-source members are provided at a side of the photoreceptor to facilitate projection light to travel along the light guiding zone of the photoreceptor.

3. The dynamic light-spot pictures generation device, according to claim 1, wherein the reflection point which is provided on the surface of the light guiding zone of the photoreceptor is a pore which is concaved inward from the surface by a proper depth.

4. The dynamic light-spot pictures generation device, according to claim 3, wherein the pore of the reflection point is in a triangular, rhombic, circular or other geometric shape to reflect light.

5. The dynamic light-spot pictures generation device, according to claim 1, wherein the light-source members are light emitting diodes or light bulbs of different colors.

6. The dynamic light-spot pictures generation device, according to claim 1, wherein the plural photoreceptors are stacked and fixed at a frame.

7. The dynamic light-spot pictures generation device, according to claim 1, wherein the plural light-source members are sheathed and fixed into the slots which are provided at the side of the frame of the photoreceptor.

8. The dynamic light-spot pictures generation device, according to claim 1, wherein the reflection points which are provided at the photoreceptor are connected by grooves of a same depth, allowing each reflection point of each photoreceptor to constitute a different continuous pattern in a groove shape, so as to form another kind of dynamic visual pictures.
